(19) United States
(12) Patent Application Publication
(10) Pub. No.: US 2011/0241998 A1
(43) Pub. Date: Oct. 6, 2011

(54) FLEXIBLE PORTABLE COMMUNICATION DEVICE

(76) Inventors: Susan MCKINNEY, Encinitas, CA (US); Glen OROSS, San Diego, CA (US); John SALISBURY, Carlsbad, CA (US)

(21) Appl. No.: 12/750,688

(22) Filed: Mar. 30, 2010

(51) Int. Cl. G06F 3/02; G09G 3/30; H04M 1/00; G09G 5/00

(52) U.S. Cl. 345/168; 345/76; 455/575.3; 345/204

(57) ABSTRACT

A portable communication device includes a housing having at least three housing portions where a first housing portion is rotatably connected to a second housing portion and the second housing portion is rotatably connected to a third housing portion. A flexible display screen is connected to the first, second, and third housing portions to form a continuous surface having a first screen portion connected to the first housing portion, a second screen portion connected to the second housing portion and a third screen portion connected to the third housing portion. The portable communication device is configurable into at least three configurations including an open position where the entire screen surface is exposed and visible to the user and a closed position where the housing portions are folded to each other such that the entire screen surface is unexposed. A partially closed position allows the user to view a portion of the display screen.

### FIELD

This invention generally relates to wireless communication devices and more particularly to a flexible portable communication device.

### BACKGROUND

Portable communication devices are devices that can transmit and/or receive wireless communication signals to exchange any combination of voice, text, data, and multimedia information. Portable communication devices may operate using any of various wireless technologies and protocols and may include devices such as cellular telephones, wireless personal data assistants (PDAs), modems, and other handheld devices. These devices typically include one or more user input devices and one or more user output devices secured within a housing. Examples of user output devices include visual displays and speakers as well as buzzers, and lights. Examples of user input devices include touchscreens, keyboards, keypads, trackballs, and microphones.

### SUMMARY

A portable communication device includes a housing having at least three housing portions where a first housing portion is rotatably connected to a second housing portion and the second housing portion is rotatably connected to a third housing portion. A flexible display screen is connected to the first, second, and third housing portions to form a continuous surface having a first screen portion connected to the first housing portion, a second screen portion connected to the second housing portion and a third screen portion connected to the third housing portion. The portable communication device is configurable into at least three configurations including an open position where the entire screen surface is exposed and visible to the user and a closed position where the housing portions are folded to each other such that the entire screen surface is unexposed. A partially closed position allows the user to view a portion of the display screen.

### BRIEF DESCRIPTION OF THE DRAWINGS

FIG. 1A is a block diagram of a perspective view of a flexible portable communication device.

FIG. 1B is a block diagram of a top view of the flexible portable communication device.

FIG. 1C is a block diagram of a side view of a flexible portable communication device.

FIG. 2A is an illustration of a perspective view of the portable communication device in an open configuration.

FIG. 2B is an illustration of a perspective view of the portable communication device in a partially closed configuration.

FIG. 2C is an illustration of a perspective view of the portable communication device in the open configuration, a partially closed configuration, and a closed configuration, respectively.

FIG. 3A is an illustration of a perspective view of the portable communication device in the partially closed configuration where a shape modifiable user input device is in a flat configuration.

FIG. 3B is an illustration of a perspective view of the portable communication device in the partially closed configuration where the shape modifiable user input device is in a raised configuration.

FIG. 4 is an illustration of a perspective view of the portable communication device in the partially closed configuration where the shape modifiable user input device is a shape altering keyboard.

FIG. 5A is a block diagram of a cross-sectional side view of the shape modifiable user input device in the flat configuration.

FIG. 5B is a block diagram of a cross-sectional side view of the shape modifiable user input device in the raised configuration.

FIG. 6 is a block diagram of the portable communication device including display controller and an input device controller.

### DETAILED DESCRIPTION

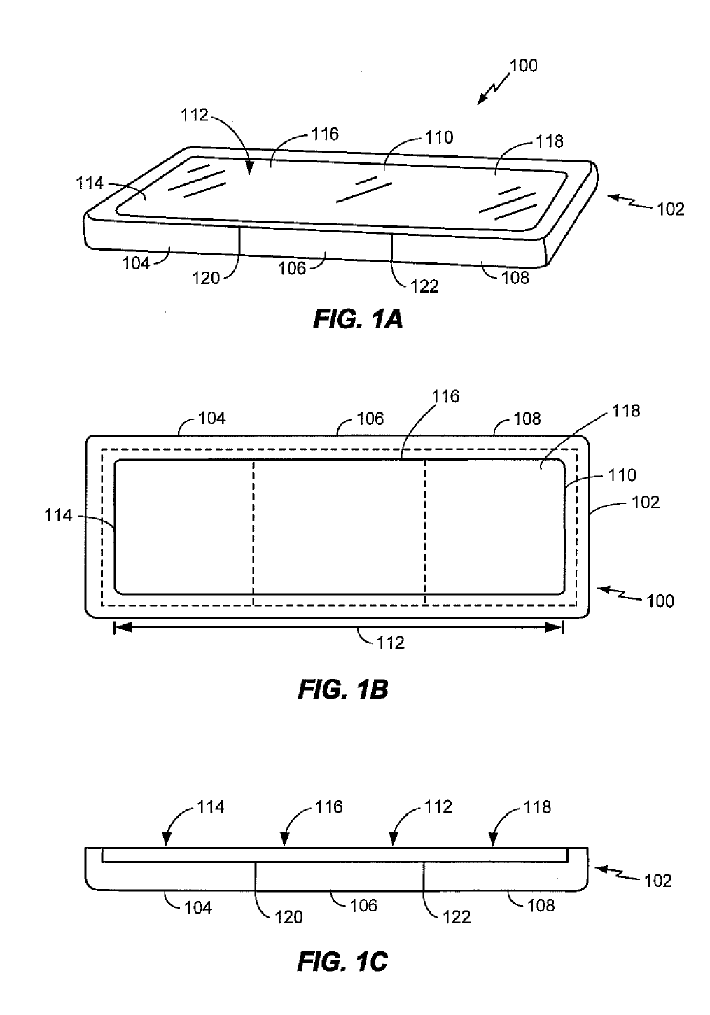

FIG. 1A is a block diagram of a perspective view of a flexible portable communication device 100. FIG. 1A is a block diagram of a top view of the portable communication device 100 and FIG. 1C is a block diagram of a side view of the portable communication device 100. A housing 102 of the portable communication device 100 includes a first housing portion 104, a second housing portion 106, and a third housing portion 108. As described below in further detail, the housing portions 102, 104, 106 are rotatably coupled to each other such that the portable communication device 100 can be folded into a tri-fold (folded) configuration or a partially folded configuration. The portable communication device 100 can also be unfolded in an open configuration as shown in FIG. 1A, FIG. 1B, and FIG. 1C. A flexible display screen 110 is connected to the first housing portion 104, second housing portion 106, and the third housing portion 108 to form a continuous surface 112 having a first screen portion 114 connected to the first housing portion 104, a second screen portion 116 connected to the second housing portion 106 and a third screen portion 118 connected to the third housing portion 108. The flexible display screen 110 generates images in response to input signals and is any display screen that can be folded, bent or otherwise distorted to form the various configurations of the portable communication device 100 without damage to the display screen. In some circumstances, the flexible display screen 110 is also a user input device, such as a touchscreen. An example of a suitable flexible display screen 110 is a Flexible Organic Light Emitting Diode (FOLED) display.

The first housing portion 104 and the second housing portion 106 are rotatably coupled to each other and the second housing portion 106 and the third housing portion 108 are rotatably coupled to each other. Accordingly, the first housing portion 104 rotates relative to the second housing portion 106 around a pivot point 120 and the third housing portion 108 rotates relative to the second housing portion 106 around another pivot point 122. In the exemplary embodiment, a flexible membrane covers at least the intersections between the housing portions 104, 106, 108 to seal the housing 102 and still allow movement between the housing portions 104, 106, 108.

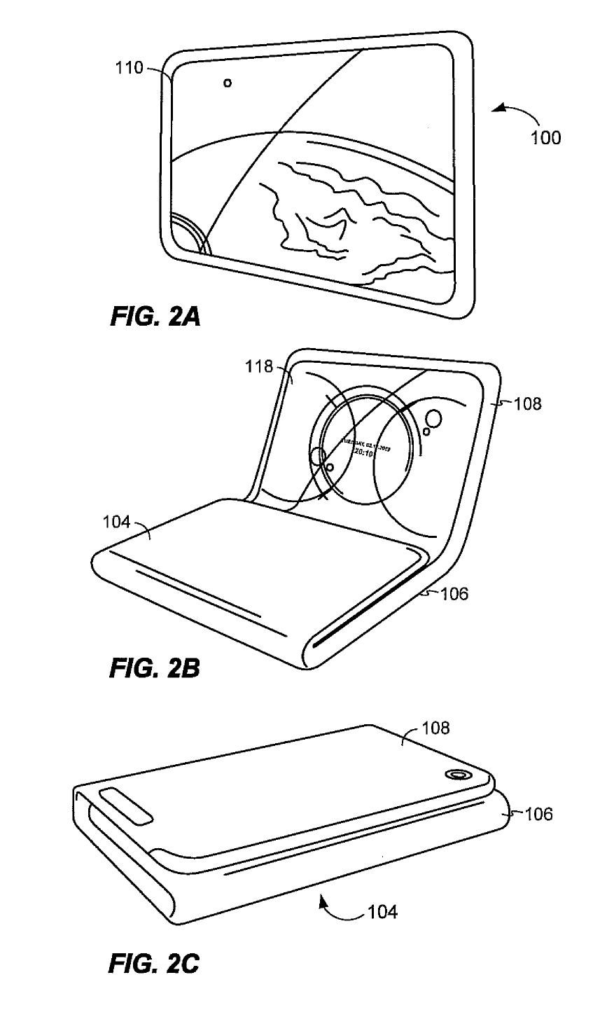

FIG. 2A, FIG. 2B and FIG. 2C are illustrations of perspective views of the portable communication device 100 in the open configuration, a partially closed configuration, and a closed configuration, respectively. Accordingly, FIG. 2A is an illustration of showing some additional esthetic features to the block diagram of FIG. 1A.

In the open configuration, the entire flexible display screen 110 can be viewed by a user of the portable communication device 100. Typically when the portable communication device 100 is in the open configuration, the display screen 110 is arranged in a single plane so that the entire screen surface 112 is flat and in the same plane. In some situations, however, the first screen portion 116 and/or the third screen portion 118 may be positioned in a plane other than the plane of the second screen portion 116. Such an arrangement occurs when the angle between the first housing portion 104 or the third housing portion 108 and the second housing portion 106 is less than 180 degrees. The open configuration allows the user to view the entire screen 110 without obstruction. Accordingly, in the open configuration, the first screen portion 114, the second screen portion 116, and the third screen portion 118 are exposed.

In the partially closed configuration, the first housing portion 104 is folded to the second housing portion 106 to cover the first screen portion 114 and the second screen portion 116. Accordingly, the third screen portion 118 is viewable in the partially closed configuration. As discussed below in further detail, a display controller controls a display driver circuit to deactivate the first screen portion 114 and the second screen portion 116 in the partially closed configuration. Limiting operation of the screen 110 only to the third screen portion 118 reduces power consumption.

In the closed configuration, the first housing portion 104, the second housing portion 106, and the third housing portion 108 are folded to cover the first screen portion 114, the second screen portion 116, and the third screen portion 118. As a result, no portion of the flexible display screen 110 is viewable in this configuration. Although no images can be viewed, the portable communication device 100 still performs functions that do not require visibility of the display screen. Output devices such as speakers and other transducers as well as lights and LEDs provide information to the user. Input devices such as buttons and keypads accept user input.

In the exemplary embodiment, therefore, the portable communication device 100 resembles a tri-fold wallet where the flexible display screen 110 is disposed on an inner surface. The housing portions 104, 106, 108 can be folded to each other in a similar manner to a tri-fold wallet such that the inner surface is unexposed to cover the flexible display screen 110. In this way, the portable communication device 100 can be folded into a compact shape where the flexible display screen 110 is protected from undesired contact and damage. The user can partially unfold the device 100 to expose only a portion 118 of the screen 110 and possibly a surface that includes a user input device such as a keypad. Where a view of the entire display screen is preferred, the portable communication device is completely unfolded into the open configuration.

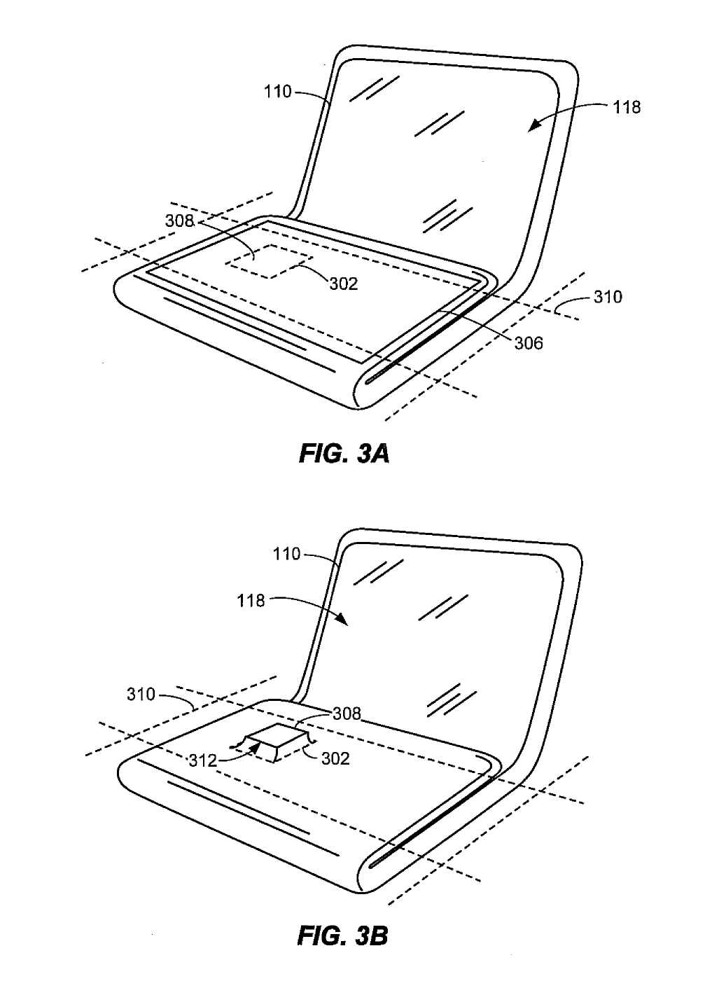

FIG. 3A and FIG. 3B are illustrations of perspective views of the portable communication device in the partially closed configuration. A shape modifiable user input device 302 is formed on a surface 304 of the portable communication device 100. The user input device 302 is formed on an interface surface on the first housing portion 104 in the example. The user input device 302 may be formed on other portions of the portable communication device in some situations. The user input device 302 is configured into at least two configurations including a flat configuration and a raised configuration. The user input device 302 is responsive to control signals to configure the user input device 302 into one of the two configurations. FIG. 3A shows the user input device 302 in the flat configuration and FIG. 3B shows the user input device 302 in the raised configuration. The interface surface 306 includes at least one section 308 that is raised out of the surface plane 310 of the interface surface 306. In the flat configuration, the surface section 308 is coplanar with the rest of the interface surface 306. In response to control signals, a shape altering mechanism extends at least one section (308) of the interface surface 306 to create a raised portion 312. The raised portion 312 may have any shape which typically depends on the intended function. The user input device 302 includes at least one input detector, such as sensor device, positioned below the surface section 308 and is configured to generate an input control signal when a force is applied to the surface section 308. As discussed below, the user input device 302 is a keyboard in the exemplary embodiment where several keys are formed in the interface surface 306.

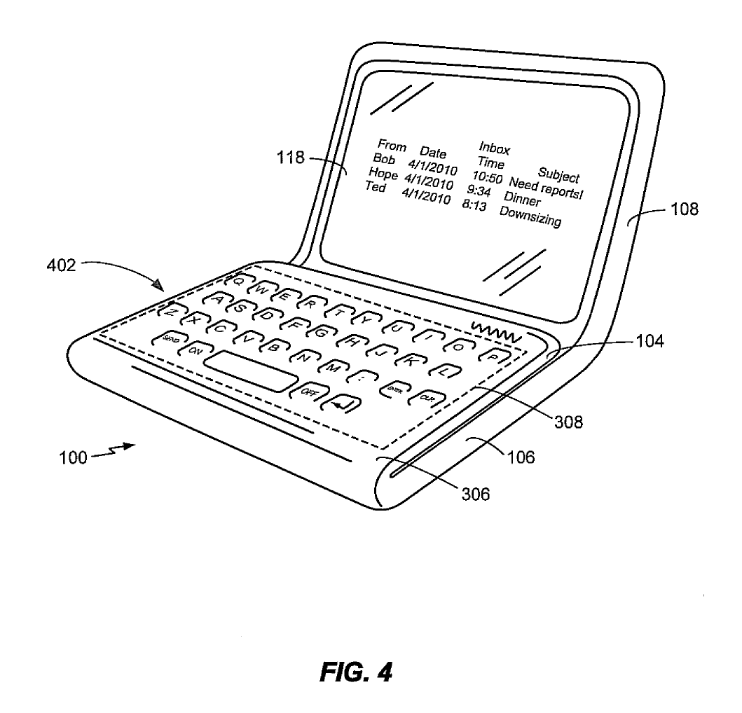

FIG. 4 is an illustration of a perspective view of the portable communication device 100 in the partially closed configuration where the shape modifiable user input device 302 is a shape altering keyboard 402. For the example of FIG. 4, therefore, at least one section of surface (surface section 306) includes several sections of the interface surface arranged to form the keyboard 402 in the raised configuration. An input sensor is positioned adjacent to each key surface section to form a key of the keyboard. When a user presses on the raised portions of the interface surface, the input sensor detects the user input and generates an input control signal corresponding to the particular key.

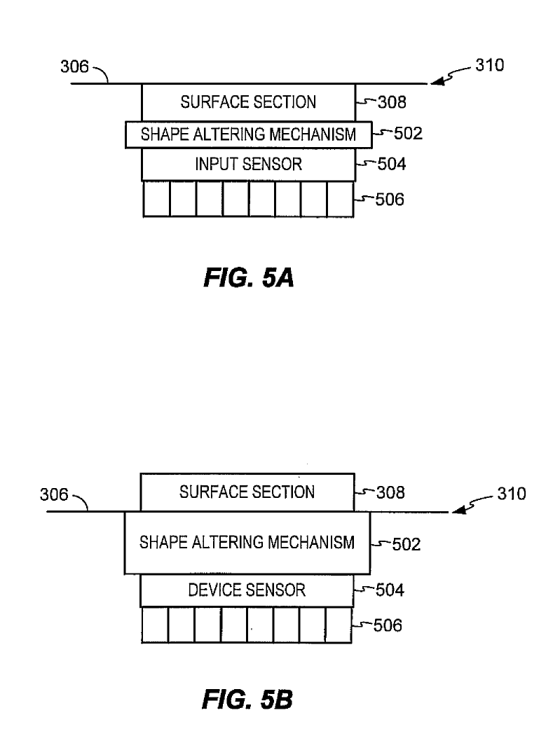

FIG. 5A and FIG. 5B are block diagrams of side views of the shape modifiable user input device 302. As described above, the surface section 306 of the interface surface 306 is raised out from the plane 310 of the interface surface 306 in the raised configuration. In response to control signals, a shape altering mechanism 502 raises the surface section 308. In the exemplary embodiment, the shape altering mechanism 502 is implemented using a shape memory polymer responsive to electrical signals. In accordance with known techniques, a section of the shape memory polymer is disposed below the surface section in the appropriate shape and size. As is known, shape memory polymers (SMPs) are polymeric smart materials that can be changed between a deformed state and a permanent state with a trigger such as an electrical or magnetic field. In some cases, the shape of the SMP may be changed to a third shape. In the exemplary embodiment, an input device controller induces an electrical field across the shape memory polymer to extend the surface section 308. In some circumstances, other types of shape altering mechanisms are used. Examples of other suitable materials and techniques include Electric Active Plastic (EAP) technologies, piezoelectric materials, shape memory alloys, magnetostrictive materials, magnetic shape memory alloys, and other smart materials, as well as techniques using air chambers and other mechanical systems. Although an exposed portion of the section of SMP may form the section of surface exposed to the user, a flexible material may be used to cover the portable communication device and the input device.

FIG. 5A is a block diagram of a cross-sectional side view of the shape modifiable user input device 302 in the flat configuration. The surface section 308 may include one or more portions of the surface 306 that are extended as discussed with reference to FIG. 5B. When the user input device is in the flat configuration, the surface section 308 is disposed coplanar with the device surface 306 in the surface plane 310. The shape altering mechanism 502 controls the relative positioning of the surface section 308 to the plane 310 of the input device surface 306. The shape altering mechanism 502 is placed in a configuration that allows the surface section 308 to be in the same plane (310) as the remainder of the surface when in the flat configuration. A control signal from a device controller applies the appropriate external stimulus (or non-stimulus) such that the shape altering mechanism 502 has a shape and size that does not extend the surface section 308 beyond the surface 306. Where the shape altering mechanism 502 is an Electric Active Plastic (EAR) or electrically triggered shape memory polymer, for example, the control signal from the input device controller results in an electrical field, current, and or voltage that does not cause the shape altering mechanism to extend the surface section.

In response to a control signal, the shape altering mechanism 502 changes shape to extend the surface section 308 out from the plane 310 of the input device surface 306. As shown in FIG. 5B, the surface section 308 is raised from the surface when the user input device 302 is in the raised configuration. Where the shape altering mechanism 502 is an Electric Active Plastic (EAP) or electrically triggered shape memory polymer, for example, the control signal from the device controller results in an electrical field, current, and or voltage that causes the shape altering mechanism 502 to extend the surface section 308. In some circumstances, the surface section 308 is part of the shape altering mechanism 502. Where EAP techniques are used, for example, the surface of the EAP may be the surface section 308.

An input sensor 504 is arranged and positioned such that the input sensor detects a force applied to the surface section 308 at least when the user input device 302 is in the raised configuration. In some situations, the input sensor 504 may also be able to detect forces applied to surface section 308 when the user input device 302 is in the flat configuration. In accordance with known techniques, the input sensor 504 is disposed in a location and manner to allow detection of the user inputs applied to the surface section 308. A user input control signal is generated and processed by electronics in the portable communication device 100 to interpret the force as a user input.

In the exemplary embodiment, a plurality of piezoelectric devices 506 are positioned adjacent to the user input device 302 and configured to generate an electrical charge when the force is applied to the section surface. For the example shown in FIG. 5A and FIG. 5B, the piezoelectric devices 506 are positioned next to the input sensor 504. In some circumstances, the piezoelectric devices 506 are positioned between the input sensor 504 and the shape altering mechanism 502. Further, the piezoelectric devices 506 can also be positioned between the surface section 308 and the shape altering mechanism 502 in some situations. The arrangement, configuration, shape, and size of the piezoelectric devices, surface section, shape altering mechanism and device sensor are selected to facilitate detection of user input and to generate charge from the user input. The piezoelectric devices 506 are arranged and connected in accordance with known techniques.

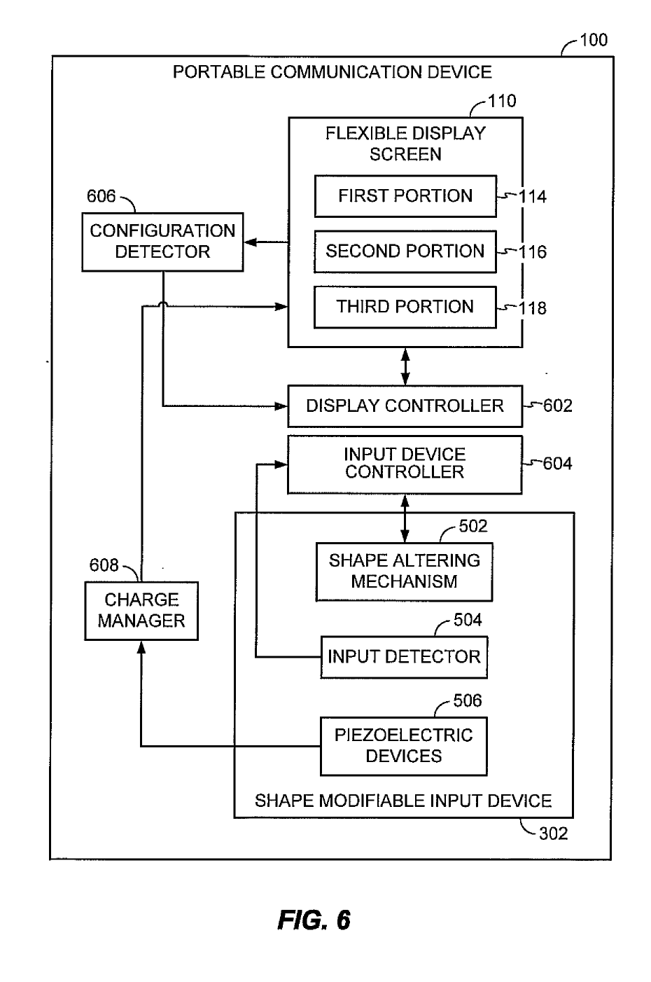

FIG. 6 is a block diagram of the portable communication device including display controller 602 and an input device controller 604. The display controller 602 is a combination of electronics and code that sends signals to generate images on the flexible display screen 110. Accordingly, the display controller 602 includes a display driver (not shown) for controlling the flexible display screen 110. In response to the detection of certain conditions, the display controller 602 disables one or more portions of the flexible display screen 110. Disabling a portion of the screen 110 reduces overall power consumption by the flexible display screen 110. In accordance with known techniques, power is reduced for a section of the flexible display screen when the section is disabled. One example for reducing power includes driving the screen 110 to limit images only to areas of the screen 110 that are not to be disabled.

Another suitable example includes implementing a system where the flexible display screen 110 has a matrix of screen portions where the matrix includes a plurality of columns and a plurality of rows. A first set of power drivers are associated with the plurality of columns and a second set of power drivers are associated with the plurality of rows. The display controller 602 controls the display on the display screen by sending control signals that generate the images as well as sending control signals for limiting power in this example. Switches couple the power drivers to the display controller 602. A power control module in the display controller 602 is connected to the power switches and the power drivers and selectively controls power to the power drivers by managing the states of the power switches.

In the exemplary embodiment, a configuration detector 606 determines the configuration of the portable communication device 100 and provides a signal to the display controller 602 indicating the configuration. The configuration detector 606 is any device that can detect the relative positions of the housing portions 104, 106, 108. Examples of suitable configuration detectors 606 include touch switches and light sensors that generate signals based on the proximity of one housing portion to another.

In the example, the display controller 602 generates signals based on the signals provided by the configuration detector 606 to present images on the flexible display screen such that images are only displayed on the third screen portion 118 when the portable communication device 100 is in the partially closed configuration. The entire display screen 110 is enabled in the open configuration. In some situations, the display on the screen 110 may also be limited in the open configuration.

The input device controller 604 includes electronics and code for managing the shape modifiable input device 302. The input device controller 604 generates control signals to control the shape altering mechanism 502. As discussed above, the shape altering mechanism 502 extends or retracts the surface section 308 in response to the control signals to place the shape modifiable input device 302 in at least one of the two configurations including the flat configuration and the raised configuration. The input detector 504 generates user input signals in response to forces applied to the surface section 308. The input device controller 604 receives the user input signals to interpret the user input.

A charge manager 608 manages the charge generated by the piezoelectric devices 506 to store and distribute power to the electronics within the portable communication device 100. The charge manager 608 may include voltage and/or current rectifiers, voltage regulators, and other electrical components as well as a processor or logic elements. Charge storage devices such as capacitors provide temporary storage of charge. In some circumstances, the portable communication device 100 may not include any batteries.

The various functions and operations of the blocks described with reference to the portable communication device 100 may be implemented in any number of devices, circuits, or elements. Two or more of the functional blocks may be integrated in a single device and the functions described as performed in any single device may be implemented over several devices. For example, the display controller 602 and input device controller 604 can be implemented as a single device or with a single processor in some circumstances.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

What is claimed is:

1. A portable communication device comprising:
a housing comprising a first housing portion, a second housing portion rotatably connected to the first housing portion, a third housing portion rotatably connected to the second housing portion; and
a flexible display screen connected to the first, second, and third housing portions to form a continuous surface having a first screen portion connected to the first housing portion, a second screen portion connected to the second housing portion, and a third screen portion connected to the third housing portion.

2. The portable communication device of claim 1, wherein the housing is configurable in at least three configurations comprising:
an open configuration where the first screen portion, the second screen portion, and third screen portion are exposed;
a partially closed configuration where the first housing portion is folded to the second housing portion to cover the first screen portion and the second screen portion; and
closed configuration where the first housing portion, the second housing portion, and the third housing portion are folded to cover the first screen portion, the second screen portion, and third screen portion.

3. The portable communication device of claim 2, further comprising a display driver circuit connected to the screen and configured to generate signals to produce images on the screen only within the third screen portion when the housing is in the partially closed configuration.

4. The portable communication device of claim 1, further comprising:
a user input device having a surface in a surface plane and responsive to control signals to configure the user input device into at least two configurations comprising a raised configuration and a flat configuration, where at least one section of the surface is raised out of the surface plane in the raised configuration and where the at least one section of surface is in the surface plane in the flat configuration, the user input device responsive to a force to the at least one section of the surface by generating an user input signal.

5. The portable communication device of claim 4, wherein the user input device comprises a shape altering mechanism responsive to the control signals to change shape to extend the section of surface out of the surface plane in the raised configuration.

6. The portable communication device of claim 5, wherein the shape altering mechanism is a shape memory polymer (SMP) responsive to an electrical trigger, the control signals generating the electrical trigger.

7. The portable communication device of claim 4, further comprising a plurality of piezoelectric devices adjacent to the user input device and configured to generate electrical charge when the force is applied to the at least one section of surface.

8. The portable communication device of claim 7, wherein the flexible display screen is a Flexible Organic Light Emitting Diode (FOLED) display.

9. The portable communication device of claim 8, further comprising electronics powered exclusively by the electrical charge.

10. A shape modifiable user input device comprising:
a shape altering mechanism responsive to control signals to configure the user input device into at least two configurations comprising a raised configuration and a flat configuration, where at least one section of a surface is raised out of the surface plane in the raised configuration and where the at least one section of the surface is in the surface plane in the flat configuration;
an input sensor configured to generate a user input signal in response to force applied to the at least one section of surface; and
a plurality of piezoelectric devices adjacent to the user input device and configured to generate electrical charge when the force is applied to the at least one section of surface.

11. The shape modifiable user input device of claim 10, wherein the shape altering mechanism is a shape memory polymer (SMP) responsive to an electrical trigger, the control signals generating the electrical trigger.

12. The shape modifiable user input device of claim 10, wherein the shape modifiable user input device is a keyboard and wherein the at least one section of surface comprises a plurality of sections of the surface, each section forming a top of a key of the keyboard.
